(19) United States
(12) Patent Application Publication
(10) Pub. No.: US 2023/0065800 A1
(43) Pub. Date: Mar. 2, 2023

(54) METHOD AND TEST ASSEMBLY FOR TESTING AN AUTONOMOUS BEHAVIOR CONTROLLER FOR A TECHNICAL SYSTEM

(71) Applicant: Siemens Aktiengesellschaft, München (DE)

(72) Inventors: Michael Brucksch, Buttenheim (DE); Markus Michael Geipel, München (DE); Jörg Neidig, Nürnberg (DE); Kai Wurm, München (DE)

(21) Appl. No.: 17/779,077

(22) PCT Filed: Oct. 26, 2020
(86) PCT No.: PCT/EP2020/080065

§ 371 Date: May 23, 2022

(30) Foreign Application Priority Data
Nov. 26, 2019 (EP) 19211427.0

(51) Int. Cl. G05B 13/04; G05B 13/02

(52) U.S. Cl. CPC G05B 13/048; G05B 13/0265

(57) ABSTRACT

In order to test an autonomous behavior controller for a technical system, the following are input: a machine model for physically simulating the technical system; an environment model modelling an environment of the technical system; as well as a disruption model modelling potential disruptions in the environment. Disruption data is generated by means of the disruption model, and the environment model is modified according to the disruption data. Environment-specifically simulated sensor data the technical system is then generated by means of the modified environment model and the machine model. According to the simulated sensor data, control data is generated for the technical system by the autonomous behavior controller. An operating behavior of the technical system induced by the control data is then simulated by means of the machine model. Furthermore, a performance value quantifying the operating behavior is determined and output as a test result.

### CROSS-REFERENCE TO RELATED APPLICATIONS

This application claims priority to PCT Application No. PCT/EP2020/080065, having a filing date of Oct. 26, 2020, which claims priority to EP Application No. 19211427.0, having a filing date of Nov. 26, 2019, the entire contents both of which are hereby incorporated by reference.

### FIELD OF TECHNOLOGY

The following relates to a method and test assembly for testing an autonomous behavior controller for a technical system.

### BACKGROUND

In many areas of technology, autonomous or semiautonomous technical systems, such as for example autonomous robots, autonomous vehicles, autonomous machine controllers or other autonomous machines, are increasingly being used that accomplish at least some predefined tasks independently and in so doing act autonomously. Technical systems of this kind do not need to be specifically programmed for each task, but rather may to a certain extent be regarded as multipurpose machines that can detect an environment and are also able to combine their capabilities in order to accomplish a predefined task. Autonomous systems are generally able to react to changes in an environment and in many cases can independently make decisions about actions that they need to perform.

In general, technical systems need to be tested before they are used in order to determine whether and to what extent they are able to meet a predefined specification and to solve predefined problems. Such a test is normally more difficult for autonomously acting technical systems than for nonautonomous systems with permanently programmed behaviors, because an actual reaction by an autonomous system is often not stipulated a priori. A further complication is that many autonomous systems are controlled by autonomous behavior controllers that are sold as black box controllers and the reaction mechanisms of which are not known or documented in detail. As such, the reaction mechanisms e.g. in the case of a neural network used for behavior control are normally not explicitly programmed, but rather are learned on the basis of training data.

To date, autonomous technical systems have often been tested by simulating their behavior in simulated operating scenarios. However, it is often difficult to cover all operating scenarios relevant to behavior in such, normally domain-specific, simulations.

### SUMMARY

An aspect relates to provide a method and a test arrangement for testing an autonomous behavior controller for a technical system that are able to be used to carry out more efficient tests.

To test an autonomous behavior controller for a technical system, in particular for an autonomous robot, for an AGV (automated guided vehicle), for an autonomous machine controller or for another autonomous machine, a machine model for physically simulating the technical system, an environment model modelling an environment of the technical system and a disruption model modelling potential disruptions in the environment are read in. The potential disruptions systematically modelled may be in particular deviations from an expected environment, from a setpoint environment or from other boundary conditions or constraints. The disruption model is used to generate disruption data, and the environment model is modelled on the basis of the disruption data. The modified environment model and the machine model are then used to generate environment-specifically simulated sensor data of the technical system. The simulated sensor data are taken as a basis for the autonomous behavior controller to generate control data for the technical system. The machine model is then used to simulate an operating behavior of the technical system that is induced by the control data. Furthermore, a performance value quantifying the operating behavior is ascertained and is output as test result. The performance value may in this instance in particular quantify a throughput, an operating speed, a resource consumption, a product quality, a precision, an accomplishment of tasks and/or a wear.

A test arrangement according to embodiments of the invention for testing an autonomous behavior controller for a technical system has a first interface for coupling the autonomous behavior controller, a second interface for coupling a machine model for physically simulating the technical system, a third interface for coupling an environment model modelling an environment of the technical system and a fourth interface for coupling a disruption model modelling potential disruptions in the environment. Furthermore, the test arrangement comprises a disruption data generator for generating disruption data by means of the disruption model and for modifying the environment model on the basis of the disruption data. In addition, the test arrangement has a simulator
for environment-specifically simulating and generating sensor data of the technical system by means of the modified environment model and the machine model,
for receiving control data for the technical system that are generated by the autonomous behavior controller on the basis of the simulated sensor data,
for simulating an operating behavior of the technical system that is induced by the control data, by means of the machine model, and
for ascertaining and outputting a performance value quantifying the operating behavior.

To carry out the method according to embodiments of the invention, there is furthermore provision for a computer program product (non-transitory computer readable storage medium having instructions, which when executed by a processor, perform actions) and a computer-readable storage medium.

The method according to embodiments of the invention, the test arrangement according to embodiments of the invention and the computer program product according to embodiments of the invention are able to be carried out or implemented for example by means of one or more processors, one or more computers, application specific integrated circuits (ASICs), digital signal processors (DSPs) and/or so-called “field programmable gate arrays” (FPGAs).

An advantage of embodiments of the invention may be seen in particular in that an autonomous behavior controller is able to be tested and assessed under systematically generated disruptive influences. The control behavior under disruptive influences is a fundamental assessment scale for autonomous controllers inasmuch as the aim with these is naturally for them to be able to handle even unforeseen situations or other disruptions. A further advantage may be seen in that the models used can easily be interchanged or specifically modified in order thus to test and/or compare different technical systems in different environments under different disruptive influences.

According to an advantageous embodiment of the invention, the disruption model may also model potential disruptions to the technical system. It is thus also possible for the machine model to be modified on the basis of the disruption data. In particular, the disruption data may be taken as a basis for modifying a behavior of a sensor and/or an actuator of the technical system in the machine model. The modified machine model may then be used to generate the simulated sensor data and/or to simulate the operating behavior. The potential disruptions to the technical system that are systematically modelled may be in particular deviations from setpoint operating sequences, deviations from setpoint functions, faults, measurement inaccuracies, measurement errors and/or adjustment errors.

According to an advantageous development of embodiments of the invention, multiple modifications of the disruption model may be generated or read in, and the performance value may be ascertained for a respective modification of the disruption model. In particular, a modification of the disruption model may be optimized on the basis of the respective performance value to the effect that a resultant performance of the technical system is reduced. Optimization will also be understood in this instance to mean convergence on an optimum. This allows specific ascertainment of disruptions that result in the autonomous behavior controller or the technical system failing. This may be used to infer a measure of the harmfulness of specific disruptions and a measure of the robustness of the autonomous behavior controller.

The disruption model may be modified in particular by reading in disruption model parameters by way of a user interface, reading in measured or predefined disruption model parameters from a database and/or replacing at least part of the disruption model with another disruption model that is read in by way of a disruption model interface. Furthermore, the disruption model parameters may be varied by means of a gamification method. A gamification method may be used to organize the variation of the disruption model parameters as part of a game, in particular an online game, the playing success of which or playing motivation of which is geared to the desired optimization aim. In addition, the disruption model parameters may be varied by means of a machine learning method, in particular a reinforcement learning method. In particular, a neural network may be trained for the autonomous behavior controller failing.

According to a further advantageous embodiment of the invention, a task model specifying a job description for the technical system may be read in. The task model may then be modified on the basis of the disruption data, and the control data may be generated by means of the modified task model. This also allows deviations or disruptions in a job description for the technical system to be systematically modelled and taken into consideration during testing.

In addition, performance values ascertained for different disruption data may be used to ascertain
a statistical distribution of the performance values,
an extreme performance value, an associated operating behavior and/or an associated disruption indicator,
a correlation between disruptions and performance values and/or
a probability of task accomplishment or of failure of the technical system and to output it/them as test result.

This makes it possible to ascertain whether and to what extent a performance of the technical system is influenced by disruptions.

### BRIEF DESCRIPTION

Some of the embodiments will be described in detail, with reference to the following figures, wherein like designations denote like members, wherein:

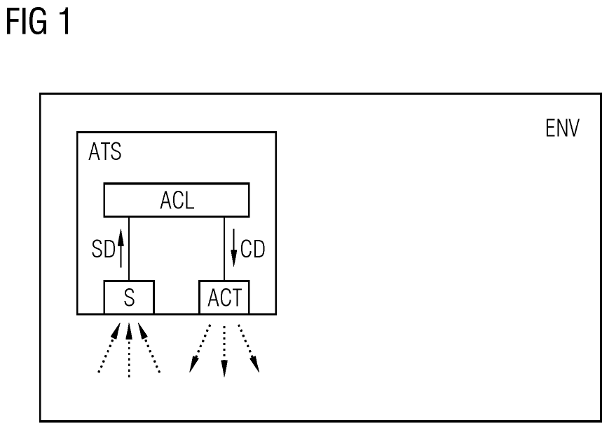

FIG. 1 shows an autonomous technical system; and

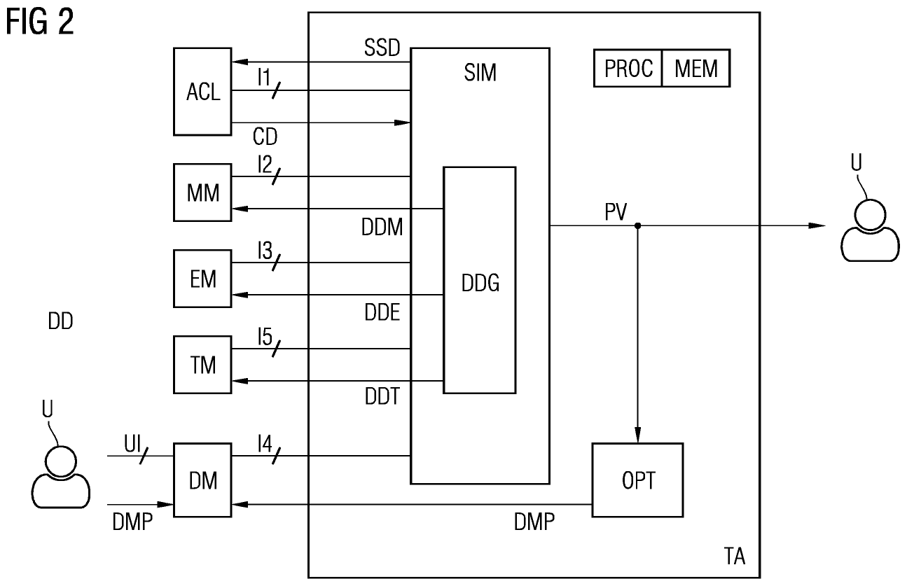

FIG. 2 shows a test arrangement according to the invention for testing an autonomous behavior controller for the autonomous technical system.

### DETAILED DESCRIPTION

FIG. 1 shows a schematic representation of an autonomous technical system ATS that acts autonomously in an environment ENV and performs tasks predefined therein largely independently. By way of example, the autonomous technical system ATS may be an autonomous, in particular mobile, robot, an autonomous vehicle, an autonomous machine controller, a so-called AGV (automatic guided vehicle) or another machine, in particular a Turing machine. The environment ENV of the autonomous technical system ATS may be e.g. a factory building in the case of a production robot or an AGV, a traffic environment in the case of an autonomous vehicle, and a warehouse in the case of a logistics robot. The environment ENV may in particular also comprise objects that are to be manipulated or handled by the autonomous technical system ATS.

The autonomous technical system ATS has an autonomous behavior controller ACL that controls an autonomous behavior of the autonomous technical system ATS in the course of operation. The autonomous behavior controller ACL in this instance makes largely independent decisions about actions to be performed by the autonomous technical system ATS. Autonomous behavior controllers of this kind frequently contain specific know-how from their manufacturer and are therefore often implemented and sold as black box controllers. This results in many implementation details of autonomous behavior controllers of this kind not being known to a user.

The autonomous technical system ATS furthermore has a sensor system S for detecting and surveying the environment ENV and for measuring operating parameters of the autonomous technical system ATS. The sensor system S may in particular comprise image sensors, acoustic sensors, acceleration sensors, force sensors and/or motion sensors. Furthermore, the autonomous technical system ATS comprises various actuators ACT that act in the environment ENV and/or act on the environment ENV. The sensor system S and the actuators ACT are each coupled to the autonomous behavior controller ACL.

In the course of operation, measurements by the sensor system S in the form of sensor data SD are quantified, said sensor data being transmitted from the sensor system S to the autonomous behavior controller ACL. The latter evaluates the transmitted sensor data SD and, on the basis of that, decides about actions to be performed by the autonomous technical system ATS. As a result, the autonomous behavior controller ACL generates control data CD for controlling the actuators ACT. The generated control data CD are transmitted from the autonomous behavior controller ACL to the actuators ACT and cause the latter to perform the scheduled actions of the autonomous technical system ATS.

FIG. 2 shows a schematic representation of a test arrangement TA according to embodiments of the invention for testing an autonomous behavior controller ACL for the autonomous technical system ATS. Where the same reference signs are used in FIG. 2 as in FIG. 1, these reference signs denote the same or corresponding entities, which in particular may be implemented or configured as described above.

The test arrangement TA has one or more processors PROC for performing method steps of the test arrangement TA and has one or more memories MEM coupled to the processor PROC for storing the data that are to be processed by the test arrangement TA.

The test arrangement TA furthermore has a first interface I1 for coupling the autonomous behavior controller ACL and has further individual interfaces I2, . . . , I5 for coupling models MM, EM, TM and DM of different type that are to be used for simulating the autonomous technical system ATS. These models each model specific behavior-relevant aspects of the autonomous technical system ATS, its use and its environment. The interfaces I1, . . . , I5 are configured independently or largely independently of an internal implementation of the autonomous behavior controller ACL and of the models MM, EM, TM and DM. The above modules ACL, MM, EM, TM and DM may therefore each be controlled as a separate black box module by way of the interfaces I1, . . . , I5. This permits black box modules from different manufacturers to be used and easily interchanged.

The modules ACL, MM, EM, TM and DM are e.g. read in from a database and coupled to the test arrangement TA by way of the interfaces I1, . . . , I5. Specifically:

The first interface I1 is used to couple the autonomous behavior controller ACL to the test arrangement TA as a black box controller, independently of its internal implementation. The test arrangement TA leads the coupled autonomous behavior controller ACL to believe that the autonomous technical system ATS is coupled and in operation. The autonomous behavior controller ACL therefore does not need to implement a specific test mode, but rather can react as it would react during normal operation of the autonomous technical system ATS.

The second interface I2 is used to couple the machine model MM for physically simulating the autonomous technical system ATS. The machine model models, or specifies, a geometry, kinematics and/or dynamics of the autonomous technical system ATS and in particular its actuators ACT and its sensor system S and also the measurement models thereof.

The third interface I3 is used to couple the environment model EM to the test arrangement TA. The environment model EM models, specifies and/or represents an environment of the autonomous technical system ATS and in particular a geometry of this environment. Objects that are to be manipulated or handled by the autonomous technical system ATS and are located in the environment or are part of the environment are also modelled by the environment model EM.

The fourth interface I4 is used to couple the disruption model DM to the test arrangement TA. The disruption model DM systematically models potential disruptions during the operation of the autonomous technical system ATS. The disruptions modelled may be in particular deviations from a scheduled or expected setpoint operating sequence, deviations from a setpoint function, deviations from a setpoint effect, deviations from envisaged equipment and/or deviations from boundary conditions or other constraints.

In particular, the disruption model DM models potential disruptions in the environment of the autonomous technical system ATS. These may be in particular static or dynamic obstacles, machines or human beings that appear in the environment, variations of a positioning of objects to be machined or handled, variations or deformations of these objects, variations in lighting conditions, weather variations and/or temperature changes. As such, multiple people moving according to a predefined motion profile may be added to the environment of the autonomous technical system ATS simulatively. In addition, ambient lighting may have its intensity, color or angle of incidence varied, e.g. in order to test optical sensors of the autonomous technical system ATS. The disruption model DM may furthermore model disruptions to the autonomous technical system ATS, in particular to its sensor system S and its actuators ATS. This allows sensor faults, adjustment errors, measurement errors or other inaccuracies to be systematically modelled. The disruption model DM may be implemented specifically for a respective autonomous technical system ATS or for one or more of its components and/or on an environment-specific basis. Alternatively or additionally, the disruption model DM may also model cross-machine, cross-component or cross-environment disruptions.

The fifth interface I5 is used to couple the task model TM to the test arrangement TA. The task model TM specifies or models a job description or a description of tasks to be performed by the autonomous technical system ATS. The task model TM may also model task-relevant objects to be machined or handled by the autonomous technical system ATS. In particular, the task model TM may comprise a so-called bill of materials (BOM) and/or a so-called bill of process (BOP). The disruption model DM also models potential disruptions to the job description for the autonomous technical system ATS, e.g. a brief change of task on account of a prioritized event.

In the present exemplary embodiment, the autonomous behavior controller ACL is in particular coupled to a simulator SIM of the test arrangement TA by way of the first interface I1. The specific models MM, EM, DM and TM are also coupled to the simulator SIM by way of the interfaces I2, I3, I4 and I5. The above models MM, EM, DM and TM are each implemented by one or more data structures that specify and/or quantify properties, capabilities, adjustment values, a geometry, kinematics, dynamics and/or other model parameters of the autonomous technical system ATS, its environment, the potential disruptions or the job description.

The models MM, EM, TM and DM are each coupled to the test arrangement TA as a separate module, the interfaces I2, I3, I4 and I5 each being implemented independently of internal model details. This permits easy interchange of the machine model MM with other machine models, the environment model EM with other environment models, the task model TM with other task models and the disruption model DM with other disruption models. This allows the test arrangement TA to be employed flexibly and to be used for quite different technical systems ATS and environments. In particular, different technical systems may be tested in a comparable manner by simply interchanging the machine model MM. Interchange of the environment model EM, the task model TM or the disruption model DM also allows the tests to be easily referenced to different environments, different job descriptions or different disruptive influences. In addition, the models MM, EM, TM and DM are reusable for different test scenarios.

The disruption model DM furthermore has a user interface UI for one or more users U. The user interface UI is used for configuring, extending and/or at least partially interchanging the disruption model DM. The user interface UI may in particular comprise a network interface, e.g. to the Internet. This allows the disruption model DM to be optimized using a so-called gamification method. The optimization in this instance is organized as part of a game, with a reward or motivation in the game being geared to a desired optimization success. The user interface UI may furthermore comprise a disruption model interface for replacing at least part of the disruption model DM. Alternatively or additionally, there may be provision for another configuration interface for the disruption model DM, which configuration interface is used to perform configuration or optimization by way of a machine learning system, in particular by means of a neural network.

In the present exemplary embodiment, the test arrangement TA and in particular the disruption model DM are initialized in an initialization phase after a preconfiguration by a user U, which involves the models MM, EM, TM and DM being selected and coupled and a test scenario being chosen.

In the initialization phase, the test arrangement TA uses the disruption model DM to ascertain which disruptions are applicable in the chosen test scenario and to what extent. This can involve ascertaining potential disruptions in the environment of the autonomous technical system ATS on the basis of the environment model EM, potential disruptions to the autonomous technical system ATS on the basis of the machine model MM and/or potential disruptions to a job description on the basis of the task model TM. Depending on this, information about manipulable disruption model parameters DMP is transmitted from the disruption model DM to the user U by way of the user interface UI. In particular, information concerning which disruption model parameters DMP are available and to what extent they are variable is transmitted. The disruption model parameters DMP specify disruptions to the autonomous technical system ATS, in particular to its sensor system S and the actuators ACT, disruptions in the environment of the autonomous technical system ATS and disruptions to the job description. On the basis of this information, the disruption model DM is actively configured by the user U by inputting or modifying the disruption model parameters DMP by way of the user interface UI. Alternatively or additionally, the disruption model parameters DMP may be modified by way of a gamification method or by means of a machine learning system, as mentioned above.

To initialize the autonomous behavior controller ACL, the machine model MM is used to ascertain information about actuators, here ACT, of the autonomous technical system ATS that are controllable by the autonomous behavior controller ACL and to transmit said information to the autonomous behavior controller ACL. In addition, the machine model MM is used to transmit information about the sensor system S of the autonomous technical system ATS to the autonomous behavior controller ACL.

After the initialization phase, an operating behavior of the autonomous technical system ATS for a predefined job description under the influence of disruptions is simulated by the simulator SIM of the test arrangement TA. The simulator SIM implements a physical simulation environment for the autonomous technical system ATS. To this end, the simulator SIM uses the interfaces I1, I2, I3, I4 and I5 to access the autonomous behavior controller ACL, the machine model MM, the environment model EM, the disruption model DM and the task model TM.

The simulator SIM uses the machine model MM to simulate a physical behavior of the autonomous technical system ATS, in particular a physical behavior of its sensor system S and its actuators ACT. Furthermore, the simulator SIM uses the environment model EM to simulate an environment of the autonomous technical system ATS, uses the task model TM to simulate an accomplishment of tasks or a job description and uses the disruption model DM to simulate potential disruptions in the current test scenario. During the simulation, the models MM, EM, TM and DM each transmit, among other things, a stream of control events to the simulator SIM, which consequently transmits data about a simulated reaction of the autonomous technical system ATS to these models.

To take account of disruptions to the operating sequence, the configured disruption model DM is used by a disruption data generator DDG to generate specific disruption data DDM for the machine model MM, specific disruption data DDE for the environment model EM and specific disruption data DDT for the task model TM. The disruption data DDM, DDE and DDT are generated in a systematic, model-driven manner in this instance. In the present exemplary embodiment, the disruption data generator DDG is implemented as a component of the simulator SIM. Alternatively or additionally, all or part of the disruption data generator DDG may also be arranged externally to the simulator SIM. The disruption data DDM, DDE and DDT each comprise data, variable values or parameter values quantifying specific disruptions. Alternatively or additionally, the disruption data DDM, DDE and DDT may also contain simulation models or simulation submodels for simulating specific disruptions. In particular, the disruption data DDM, DDE and DDT may also comprise random data.

The disruption data generator DDG transmits the disruption data DDM to the machine model MM, the disruption data DDE to the environment model EM and the disruption data DDT to the task model TM. The models MM, EM and TM are each modified in a disruption-specific manner on the basis of the respective transmitted disruption data DDM, DDE and DDT.

To simulate the disruption-specific or disruption-indicated behavior of the autonomous technical system ATS, the simulator SIM uses the modified environment model EM and the modified machine model MM to generate environment-specifically and machine-specifically simulated sensor data SSD and to transmit them to the autonomous behavior controller ACL. The autonomous behavior controller ACL evaluates the simulated sensor data SSD and, on the basis of this, and using the modified task model TM, decides about actions to be performed by the autonomous technical system ATS. On the basis of the actions to be performed, the autonomous behavior controller ACL then generates control data CD that would cause the actuators ACT of the autonomous technical system ATS to perform these actions. The control data CD are transmitted from the autonomous behavior controller ACL to the simulator SIM. On the basis of this, the simulator SIM uses the modified machine model MM and uses the modified environment model EM to simulate an operating behavior of the autonomous technical system ATS that is induced by the received control data CD. In addition, the simulator SIM assesses the simulated operating behavior and, on the basis of this, generates performance values PV that quantify the simulated operating behavior in a predefined manner.

The performance values PV in this instance may quantify in particular a throughput, an operating speed, a resource consumption, action cycle times, a product quality, an accuracy, an accomplishment of tasks, an operating temperature and/or a wear, in particular on the basis of the disruptions generated.

The performance values PV are output by the simulator SIM as test results. The performance values PV are output in association with the disruptions or disruption data on which the simulation is based. This allows an influence of a respective disruption on a performance of the autonomous technical system ATS to be identified particularly easily.

To make better use of the test scenarios, the test arrangement TA furthermore has an optimization module OPT to which the performance values PV ascertained by the simulator SIM are supplied. The optimization module OPT takes the supplied performance values PV as a basis for generating disruption model parameters DMP and transmits the latter to the disruption model DM in order to modify it as part of an optimization method. Modification of the disruption model DM varies the disruptions modelled by the disruption model DM. Accordingly, the disruption data generator DDG uses the modified disruption model DM to generate modified disruption data DDM, DDE and DDT. These modified disruption data DDM, DDE and DDT are—as described above—used to modify the machine model MM, the environment model EM and the task model TM again. Accordingly, a new operating behavior of the autonomous technical system ATS is simulated by means of the freshly modified models MM, EM and TM, and resultant performance values PV are ascertained therefrom by the simulator SIM. The freshly ascertained performance values PV are transmitted to the optimization module OPT. The above sequence is performed iteratively, with the disruption model DM being modified multiple times. The disruption model parameters DMP are iteratively optimized by the optimization module OPT on the basis of the respective supplied performance values PV to the effect that a resultant performance of the simulated autonomous technical system ATS is reduced. A multiplicity of numerical optimization methods are available for carrying out such optimization. A machine learning system, in particular a neural network and/or a reinforcement learning method, may be used for optimization.

The above approach allows specific ascertainment of disruptions or job descriptions that would result in the autonomous technical system ATS failing in accordance with the simulation. In addition, a measure of a robustness of the autonomous behavior controller ACL and/or a worst-case scenario may be inferred. The test results that are output may be in particular a statistical distribution of performance values, an extreme performance value with an associated operating behavior and/or an associated disruption indicator, a correlation between disruptions and performance values and/or a probability of task accomplishment or of failure of the technical system ATS.

The test arrangement TA according to embodiments of the invention may be used by potential users of the autonomous technical system ATS to simulatively test the accomplishment of tasks by said system and the robustness of said system toward disruptions in advance. In addition, it is possible to identify disruptions to the autonomous technical system ATS, disruptions in its environment and/or disruptions to its job description that may lead to a reduction in performance or to failure.

The test arrangement TA may also be used when building an autonomous technical system, in order to verify the behavior thereof and the robustness thereof toward disruptions as early as in the design phase. The modularity of the individual models MM, EM, TM and DM means that the test scenarios can easily be matched to different configurations of the technical system to be tested, to different environmental conditions, to different job descriptions and to different disruptive influences. The specific test results may then already be used during the design phase to design the technical system that is to be built to be robust toward specific disruptions in a specific manner.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for testing an autonomous behavior controller for a technical system, the method comprising:
a) reading in a machine model for physically simulating the technical system, an environment model modelling an environment of the technical system and a disruption model modelling potential disruptions in the environment;
b) using the disruption model, generating disruption data, wherein the environment model is modified on a basis of the disruption data;
c) using the modified environment model and the machine model, generating environment-specifically simulated sensor data of the technical system;
d) generating by the autonomous behavior controller which takes the simulated sensor data as a basis, control data for the technical system;
e) simulating, using the machine model, an operating behavior of the technical system that is induced by the control data; and
f) ascertaining a performance value quantifying the operating behavior, which is output as a test result.

2. The method as claimed in claim 1,
wherein the disruption model models potential disruptions to the technical system,
wherein the machine model is modified on the basis of the disruption data, and
wherein the modified machine model is used to generate the simulated sensor data and/or to simulate the operating behavior.

3. The method as claimed in claim 2, wherein the disruption data are taken as a basis for modifying a behavior of a sensor and/or of an actuator of the technical system in the machine model.

4. The method as claimed in claim 1, wherein multiple modifications of the disruption model are generated or read in,
wherein the performance value is ascertained for a respective modification of the disruption model, and
wherein a modification of the disruption model is optimized on the basis of the respective performance value to the effect that a resultant performance of the technical system is reduced.

5. The method as claimed in claim 4,
wherein the disruption model is modified by:
reading in disruption model parameters by way of a user interface,
reading in measured or predefined disruption model parameters from a database,
replacing at least part of the disruption model with another disruption model that is read in by way of a disruption model interface,
varying disruption model parameters by means of a gamification method and/or
varying disruption model parameters by means of a machine learning method.

6. The method as claimed in claim 1, wherein a task model specifying a job description for the technical system is read in,
wherein the task model is modified on the basis of the disruption data, and
wherein the control data are generated by means of the modified task model.

7. The method as claimed in claim 1, wherein performance values ascertained for different disruption data are used to ascertain:
a statistical distribution of the performance values,
an extreme performance value, an associated operating behavior and/or an associated disruption indicator,
a correlation between disruptions and performance values and/or
a probability of task accomplishment or of failure of the technical system and to output it/them as test result.

8. A test arrangement for testing an autonomous behavior controller for a technical system, comprising,
a) a first interface for coupling the autonomous behavior controller;
b) a second interface for coupling a machine model for physically simulating the technical system;
c) a third interface for coupling an environment model modelling an environment of the technical system;
d) a fourth interface for coupling a disruption model modelling potential disruptions in the environment;
e) a disruption data generator for generating disruption data by means of the disruption model and for modifying the environment model on the basis of the disruption data; and
f) a simulator:
for environment-specifically simulating and generating sensor data of the technical system by means of the modified environment model and the machine model,
for receiving control data for the technical system that are generated by the autonomous behavior controller on the basis of the simulated sensor data,
for simulating an operating behavior of the technical system that is induced by the control data, by means of the machine model, and
for ascertaining and outputting a performance value quantifying the operating behavior.

9. A computer program product, comprising a computer readable hardware storage device having computer readable program code stored therein, said program code executable by a processor of a computer system implement the method as claimed in claim 1.

10. A computer-readable storage medium having the computer program product as claimed in claim 9.
